(19) United States
(12) Patent Application Publication
(10) Pub. No.: US 2022/0186709 A1
(43) Pub. Date: Jun. 16, 2022

(54) REINFORCEMENT LEARNING-BASED REAL TIME ROBUST VARIABLE PITCH CONTROL OF WIND TURBINE SYSTEMS

(71) Applicant: Shanghai Maritime University, Shanghai (CN)

(72) Inventors: Peng CHEN, Shanghai (CN); Dezhi HAN, Shanghai (CN)

(21) Appl. No.: 17/260,323

(22) PCT Filed: May 22, 2020
(86) PCT No.: PCT/CN2020/091720

§ 371 Date: Jan. 14, 2021

(30) Foreign Application Priority Data
Oct. 16, 2019 (CN) 201910982917.9

(51) Int. Cl. F03D 7/02; F03D 7/04

(52) U.S. Cl. CPC F03D 7/0224; F03D 7/046; F05B 2270/328; F05B 2270/709; F05B 2270/327; F05B 2270/404; F05B 2270/335

(57) ABSTRACT

Disclosed are a system and a method for reinforcement learning-based real time robust variable pitch control of a wind turbine system. The system includes: a wind speed collecting module to collect wind speed values of a wind farm; a wind turbine information collecting module to collect a rotor angular speed; a reinforcement signal generating module to generate a reinforcement signal based on the collected rotor angular speed and the rated rotor angular speed; a variable pitch robust control module including an action network and a critic network, wherein the action network is configured to generate an action value based on the wind speed of the wind farm and the rotor angular speed and output the action value to the critic network; the critic network is configured to perform learning training based on the reinforcement signal and the action value, generate a cumulative return value and output the cumulative return value to the action network; and the action network performs learning training based on the cumulative return value to update the action value and output the updated action value; and a control signal generating module connected to the action network, configured to generate a corresponding control signal based on the received action value. The wind power generator adjusts the pitch angle based on the control signal, which realizes adjustment of the rotor angle speed and guarantees smooth and stable power output of the wind turbine.

### TECHNICAL FIELD

Embodiments of the present disclosure relate to technologies of wind power generation, and more particularly relate to systems and methods for reinforcement learning-based real time robust variable pitch control of a wind turbine system.

### BACKGROUND

Currently, technologies relating to new energies are highly valued among the international community. Various countries around the world rely on acceleration of developing renewable energies to address their environment and energy issues. Renewable energies are key future economic and technological development. Wind energy, as a type of renewable energy, is free, clean, and non-polluting. Wind power generation is highly competitive over most of other renewable energies. Many regions in China have abundant wind power resources. Therefore, development of wind power generation may provide a strong support for national economic development.

Due to the natural environments of the places where wind farms are located and the stochasticity of control variables of wind turbine systems, wind power generation systems are non-linear; therefore, to guarantee safe and stable operation of a wind turbine system, it is necessary to keep the wind turbine system constantly outputting power stably in different wind conditions. Generally, it is necessary to get knowledge of the natural environment of a wind farm, as well as the operating characteristics of the wind turbine system, which in turn requires devising a smart real-time control system.

The smart real-time control system offers an adaptability to different conditions so as to achieve an optimal wind energy utilization, which not only guarantees stable electrical energy output of the wind turbine system, but also guarantees safe operation of the wind turbine system in a complex natural condition. To mitigate the impact of uncertain factors in the wind speed model on the wind turbine system, many researchers have devised a feedback controller to address such impacts. However, most of such feedback controllers are highly demanding on dynamics.

Conventional feedback controllers based on optimal control are usually designed for offline, which require resolving a Hamilton-Jacobi-Bellman (HJB) equation or Bellman equation and leveraging a complete set of system dynamics knowledge to reach the maximum (minimum) values of a system performance indicator. However, it is always difficult or even impossible to determine the optimal control policy for a nonlinear system using the offline solution of the HJB equation or Bellman equation.

At present, many study methodologies have been proposed on variable pitch control of wind turbines. Among them, fuzzy adaptive PID (proportionalintegral derivative) control has been proposed to adjust hydraulic pressure for driving a variable pitch system, which, however, requires resetting of parameters of the algorithm based on actual circumstances during the application process, such that this methodology has a poor generalization. A proportional-integer-resonate (PI-R) pitch control approach based on Multi-Blade Coordinate (MBC) is also proposed, which can inhibit low frequency and high frequency components of an unbalanced load; however, such components are susceptible to interference from other stochastic frequency components.

### SUMMARY OF THE INVENTION

An objective of the present disclosure is to provide a system and a method for reinforcement learning-based real time robust variable pitch control of a wind turbine system. To overcome the difficulties in controlling electrical energy output of wind turbines in most wind conditions, the present disclosure relies on a reinforcement learning module including an action network and a critic network for controlling wind turbine pitch angles based on real-time captured wind speeds and rotor angular speeds. By feeding back a reinforcement signal to the reinforcement learning module, the present disclosure enables the reinforcement learning module to know whether to continue or avoid, in the next step, the same control measure as the current step. By keeping the rotor angular speed of the wind turbine system within a specified range, the present disclosure enables indirect control of the wind energy utilization ratio to vary stably.

The object above is mainly achieved through the following concepts:

To achieve the object above, a system for reinforcement learning-based real time robust variable pitch control of a wind turbine system is provided, comprising:

a wind speed collecting system configured to collect wind speed data of a wind farm to generate a real-time wind speed value;

a wind turbine information collecting module connected to a wind power generator, configured to collect a rotor angular speed of the wind power generator;

a reinforcement signal generating module in signal connection with the wind turbine information collecting module, configured to generate in real time a reinforcement signal based on the collected rotor angular speed and a rated rotor angular speed;

a variable pitch robust control module, which is also referred to as a reinforcement learning module, comprising an action network and a critic network, wherein the action network is in signal connection with the wind speed collecting system and the wind turbine information collecting module and configured to generate an action value based on the real-time wind speed value and the rotor angular speed received and output the action value to the critic network; the critic network is in connection with the wind speed collecting system, the wind turbine information collecting module, and the reinforcement signal generating module and configured to generate a cumulative return value based on the real-time wind speed value, the rotor angular speed, and the action value received, perform learning training based on the reinforcement signal received, and iteratively update the cumulative return value and the critic network; and the action network performs learning training based on the updated cumulative return value to iteratively update the action network and the action value;

a control signal generating module disposed between and in signal connection with the reinforcement learning module and the wind power generator, configured to generate, based on the set mapping function, a control signal corresponding to the action value iteratively updated by the action network, wherein the wind power generator adjusts the pitch angle based on the control signal to thereby adjust the rotor angular speed.

The action network and the critic network are both of a BP neural network, which perform learning training with a backpropagation algorithm.

A method for reinforcement learning-based real time robust variable pitch control of a wind turbine system, which is implemented by the system for reinforcement learning-based real time robust variable pitch control of a wind turbine system, comprises steps of:

S1: collecting, by a wind speed collecting system, wind speed data of a wind farm, and generating a real-time wind speed value v(t) of the wind farm based on the wind speed data; and collecting, by a wind turbine information collecting module, a rotor angular speed ω(t) of the wind power generator; where t denotes sampling time;

S2: comparing, by a reinforcement signal generating module, the rotor angular speed ω(t) with a rated rotor angular speed to generate a reinforcement signal r (t) , wherein the reinforcement signal r(t) indicates whether the difference between the rotor angular speed ω(t) and the rated rotor angular speed lies in a preset error range;

S3: calculating, by an action network, the action value u(t) at time t with the wind speed values v(t) and v(t−1) collected by the wind speed collecting system and the rotor angular speed ω(t) as inputs;

S4: calculating, by a critic network, a cumulative return value J(t) with the wind speed values v(t) and v(t−1), the rotor angular speed ω(t), and the action value u(t) as inputs to the critic network;

S5: performing, by the critic network, learning training based on the reinforcement signal r(t), and iteratively updating a network weight of the critic network and the cumulative return value J(t);

S6: performing, by the action network, learning training with the updated cumulative return value J(t) obtained in step S5, and iteratively updating the network weight of the action network and the action value u(t);

S7: outputting u(t) by the action network when the action network determines, based on the reinforcement signal r(t) , that the difference between the rotor angular speed ω(t) and the rated rotor angular speed lies in a preset error range, in which case the method proceeds to step S8; otherwise, not outputting u(t), in which case the method returns to step S1;

S8: generating, by a control signal generating module based on a preset mapping function rule, a pitch angle value β corresponding to the action value u(t) obtained in step S6, and generating a control signal corresponding to the pitch angle value β; varying, by the wind power generator based on the control signal, a pitch angle of the wind power generator to thereby adjust the rotor angular speed ω(t); and updating t to t+1, then repeating steps S1-S8.

Step S1 of collecting, by a wind speed collecting system, wind speed data of a wind farm, and generating a real-time wind speed value v(t) of the wind farm based on the wind speed data specifically comprises:

S11: generating, by the wind speed collecting system, an average wind speed value v̅=Σᵢ₌₁^{t-1}v(i)/(t−1) based on the collected wind speed values v(1)˜v(t−1), where t denotes sampling time;

S12: calculating a turbulent speed v′(t) of sampling time t according to an auto-regressive moving average method, v′(t)=Σᵢ₌₁ⁿαᵢv′(t−i)+a(t)+Σⱼ₌₁^{m}βⱼα(t−j) , where a(·) denotes a white noise sequence of Gaussian distribution, n denotes an autoregressive order; m denotes a moving average order; αᵢ denotes an autoregressive coefficient, βⱼ denotes a moving average coefficient, and σ_{α}² denotes a variance of the white noise α(t);

S13: generating the wind speed value v(t)=v̅+v′(t) of the sampling time t.

Step S2 of generating the reinforcement signal r(t) specifically comprises: if the difference between the rotor angular speed ω(t) and the rated rotor angular speed lies within a preset error range, r(t)=0; otherwise, r(t)=−1.

Step S5 specifically comprises:

S51: setting a predicted error e _{c}(k) of the critic network to e_{c}(k)=αJ(k)−[J(k−1)−r(k)], where α denotes a discount factor; setting the to-be-minimized target function E_{c}(k) of the critic network to E_{c}(k)=½e_{c}²(k), where k denotes the number of iterations; J(k) denotes a result outputted by the critic network after the k-th iteration with the wind speed value v(t), the rotor angular speed ω(t), and the action value u(t) in step S4 as inputs to the critic network, where r(k) is equal to r(t) in step S2, which does not vary with the number of iteration;

S52: setting the critic network weight updating rule to w_{c}(k+1)=w_{c}(k)+Δw_{c}(k) , and iteratively updating the network weight of the critic network based on the critic network weight updating rule;

where w_{c}(k) denotes the network weight of the critic network after the k-th iteration, Δw_{c}(k) denotes the difference value of the network weight of the critic network at k -th iteration,

$$Δ {w}_{c} ( k ) = {l}_{c} ( k ) \cdot [ - \frac{\partial {E}_{c} ( k )}{\partial J ( k )} \cdot \frac{\partial J ( k )}{\partial {w}_{c} ( k )} ] ;$$

and l_{c}(k) denotes learning rate of the critic network;

S53: when the number of iterations k reaches the set upper limit of critic network updates, or the predicted error e_{c}(k) of the critic network is less than a first error threshold as set, stopping iteration, and outputting J(k) to the action network by the critic network.

Step S6 specifically comprises:

S61: setting the predicted error of the action network to eₐ(k)=J(k)−U_{c}(k), where U_{c}(k) denotes the final expected value of the action network, which is 0; setting the target function of the action network to Eₐ(k)=½eₐ²(k), where k denotes the number of iterations; J(k) is equal to the output value of the critic network in step S53, which does not vary with the number of iterations.

S62: setting the action network weight updating rule to wₐ(k+1)=wₐ(k)+Δwₐ(k), and iteratively updating the network weight of the action network based on the action network weight updating rule;

where wₐ(k) denotes network weight of the action network at the k-th iteration, wₐ(k+1) denotes the network weight of the action network at the k+1-th iteration, and Δwₐ(k) denotes the difference value of the network weight of the action network at the k-th iteration,

$$Δ {w}_{a} ( k ) = {l}_{a} ( k ) \cdot [ - \frac{\partial {E}_{a} ( k )}{\partial J ( k )} \cdot \frac{\partial J ( k )}{\partial u ( k )} \cdot \frac{\partial u ( k )}{\partial {w}_{a} ( k )} ] ;$$

where lₐ (k) denotes learning rate of the action network; u(k) denotes the action value outputted at the k-th iteration;

S63: stopping iteration when the number of iterations k reaches the set upper limit of action network updates or the predicted error eₐ(k) of the action network is less than a second error threshold as set; and outputting, via the action network, the updated action value u(t) at time t with the wind speeds v(t), v(t−1), and the rotor angular speed ω(t) in step S3 as inputs to the action network.

The mapping function rule in step S8 specifically refers to:

if u(t) is greater than or equal to 0, taking the pitch angle value β as a preset positive number; if u(t) is less than 0, taking the pitch angle value β as a preset negative number.

The present disclosure offers the following beneficial effects:

1) the present disclosure provides a system and a method for reinforcement learning-based real time robust variable pitch control of a wind turbine system, which leverage a reinforcement learning module. The reinforcement learning module includes an action network and a critic network. With the action network and the critic network and based on the real-time collected wind speed and rotor angle speed, a control signal is generated in real time through learning trainings to adjust the wind turbine pitch angle. By feeding back a reinforcement signal to the reinforcement learning module, the present disclosure further enables the reinforcement learning module to know whether to continue or avoid, in the next step, the same control measure as the current step. In this way, the present disclosure enables real-time control of the stability of the rotor angular speed under a rated angular speed and enables the pitch angle to vary smoothly and stably. Compared with conventional variable pitch control methods, the present disclosure has less damages to the wind turbine system equipment and facilitates extending of the service life of such equipment.

2) The conventional optimal control generally requires offline design by solving an HJB equation so as to enable a given system performance index to reach the maximum value (or minimum value), which requires leveraging a complete set of system dynamics knowledge. Further, it is always difficult or even impossible to determine the optimal control policy of a nonlinear system using the offline solution of the HJB equation. However, the present disclosure can guarantee a stable power output of the wind turbine only through autonomous learning training of the reinforcement learning module using the real-time detected rotor angular speed and wind speed. The present disclosure has advantages such as quick calculation, precise control, and sensitive response, which is less demanding on dynamics. Besides, the present disclosure has a wide array of applications and a stable and reliable effect.

### BRIEF DESCRIPTION OF THE DRAWINGS

Hereinafter, the embodiments of the present disclosure will be further illustrated with reference to the accompanying drawings, wherein:

FIG. 1 shows a structural schematic diagram of a system for reinforcement learning-based real time robust variable pitch control of a wind turbine system according to the present disclosure;

FIG. 2 shows a flow diagram of a method for reinforcement learning-based real time robust variable pitch control of a wind turbine system according to the present disclosure;

FIG. 3 is a schematic diagram of an action network of the present disclosure;

FIG. 4 is a schematic diagram of a critic network according to the present disclosure;

In the drawings: 1. Wind speed collecting system; 2. Reinforcement signal generating module; 3. Variable pitch robust control module; 31. Action network; 32. Critic network; 4. Control signal generating module; 5. Wind turbine information collecting module.

### DETAILED DESCRIPTION OF EMBODIMENTS

Hereinafter, the technical solution of the present disclosure will be described in a clear and comprehensive manner with reference to the preferred embodiments in conjunction with accompanying drawings; it is apparent that the embodiments described here are part of the embodiments of the present disclosure, not all of them. All other embodiments obtained by those skilled in the art without exercise of inventive work based on the examples in the embodiments all fall within the protection scope of the present disclosure.

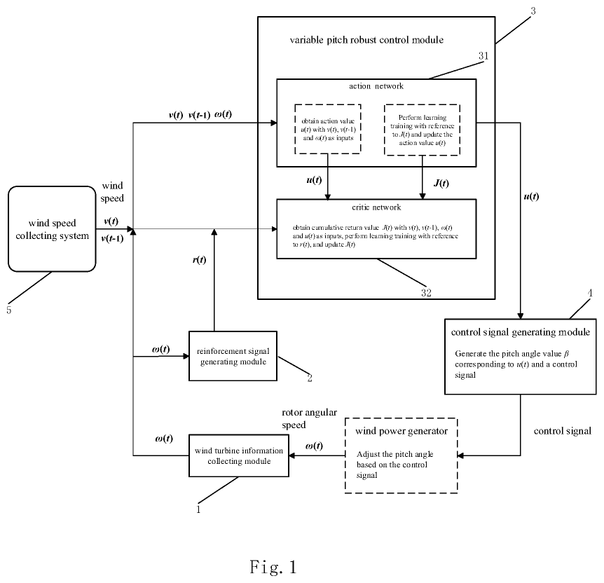

The present disclosure provides a system for reinforcement learning-based real time robust variable pitch control of a wind turbine system, as shown in FIG. 1, comprising:

a wind speed collecting system 1 configured to collect wind speed data of a wind farm to generate a real-time wind speed value;

a wind turbine information collecting module 5 connected to a wind power generator, configured to collect a rotor angular speed of the wind power generator;

a reinforcement signal generating module 2 in signal connection with the wind turbine information collecting module 5, configured to generate in real time a reinforcement signal based on the collected rotor angular speed and a rated rotor angular speed;

a variable pitch robust control module 3, which is also referred to as a reinforcement learning module, comprising an action network 31 and a critic network 32, wherein the action network 31 is in signal connection with the wind speed collecting system 1 and the wind turbine information collecting module 5 and configured to generate an action value based on the real-time wind speed value and the rotor angular speed received and output the action value to the critic network 32; the critic network 32 is in connection with the wind speed collecting system 1, the wind turbine information collecting module 5, and the reinforcement signal generating module 2 and configured to generate a cumulative return value based on the real-time wind speed value, the rotor angular speed, and the action value received, perform learning training based on the reinforcement signal received, and iteratively update the cumulative return value and the critic network 32; and the action network 31 performs learning training based on the updated cumulative return value to iteratively update the action network 31 and the action value;

a control signal generating module 4 disposed between and in signal connection with the reinforcement learning module and the wind power generator, configured to generate, based on the set mapping function, a control signal corresponding to the action value iteratively updated by the action network 31, wherein the wind power generator adjusts the pitch angle based on the control signal to thereby adjust the rotor angular speed.

The action network 31 and the critic network 32 are both of a BP neural network, which perform learning training using a backpropagation algorithm.

It is known that a wind turbine system is a facility for exploiting wind energy, and its operating status is mainly reflected by the power parameters that vary with wind speed changes. In a wind turbine system energy transmission model, there exists a wind energy utilization coefficient Cₚ, which may be approximated as

$${C}_{p} = ( 0.44 - 0.0167 β ) sin ( \frac{π ( λ - 3 )}{15 - 0.3 β} ) - 0.00184 ( λ - 3 ) β ,$$

where β denotes the pitch angle, and λ denotes the tip-speed ratio. The tip speed ratio refers to the ratio between the linear speed of the tip of the wind turbine blade and the wind speed, which is an important parameter describing the properties of the wind turbine system, expressed as

$$λ = \frac{ω R}{v} ,$$

where ω denotes the angular speed of rotor rotation, R denotes rotor radius, and v denotes wind speed. It is seen that variation of the pitch angle enables variation of the wind energy utilization ratio. Therefore, it is set to vary the pitch angle based on the output value of the action network 31.

It is known that the dynamic equation of the wind turbine system is

$$J \frac{d ω}{dt} = \frac{1}{2} ρ A {RC}_{T} {v}^{2} - {T}_{e} ,$$

where J denotes the moment of inertia of the rotor, ρ denotes air density, A denotes swept area of rotor, Tₑ denotes countertorque of engine, and C_{T} may be derived from the expression

$${C}_{T} = \frac{1}{λ} {C}_{p} .$$

The dynamic equation reveals that the wind energy utilization ratio is related to the rotor angular speed and the wind speed; therefore, the rotor angular speed and wind speed serve as inputs to the action network 31 and the critic network 32.

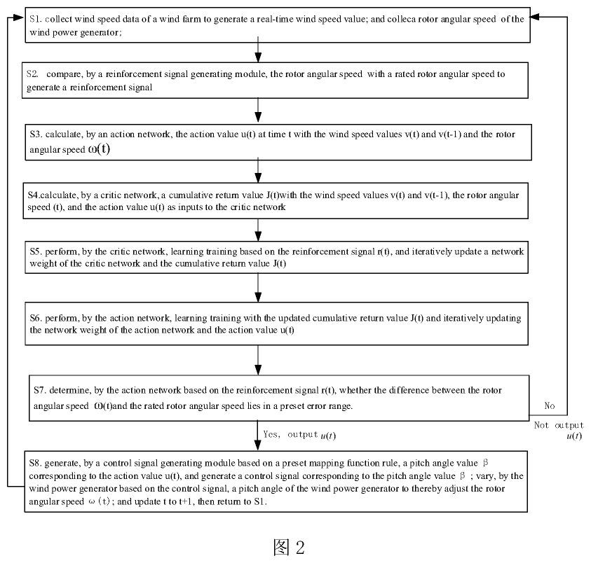

FIG. 2 shows a method for reinforcement learning-based real time robust variable pitch control of a wind turbine system, which is implemented by the system for reinforcement learning-based real time robust variable pitch control of a wind turbine system, the method comprising steps of:

S1: collecting, by a wind speed collecting system 1, wind speed data of a wind farm, generating a real-time wind speed value v(t) of the wind farm based on the wind speed data; and collecting, by a wind turbine information collecting module 5, a rotor angular speed ω(t) of the wind power generator; where t denotes sampling time;

Step S1 of collecting, by a wind speed collecting system 1, wind speed data of a wind farm, and generating a real-time wind speed value v(t) of the wind farm based on the wind speed data specifically comprises:

S11: generating, by the wind speed collecting system 1, an average wind speed value v̅=Σᵢ₌₁^{t-1}v(i)/(t−1) based on the collected wind speed values v(1)˜(t−1), where t denotes sampling time;

S12: calculating a turbulent speed v′(t) of the sampling time t using an auto-regressive moving average method, v′(t)=Σᵢ₋₁ⁿαᵢv′(t−i)+a(t)+Σⱼ₌₁^{m}βⱼa(t−j), wherein a(·) denotes a white noise sequence of Gaussian distribution, n denotes an autoregressive order; m denotes a moving average order; αᵢ denotes an autoregressive coefficient, βⱼ denotes a moving average coefficient, and σₐ² denotes a variance of white noise a(t);

S13: generating the wind speed value v(t)=v̅+v′(t) at the sampling time t.

S2: comparing, by the reinforcement signal generating module 2, the rotor angular speed ω(t) with the rated rotor angular speed to generate a reinforcement signal r(t); if the difference between the rotor angular speed ω(t) and the rated rotor angular speed lies within a preset error range, r(t)=0, indicating that control of the rotor is not passive at the sampling time t, such that similar control may be adopted for future similar statuses; otherwise, r(t)=−1, indicating that control of the rotor is passive at the sampling time t, such that similar control should be avoided for future similar statuses;

S3: calculating, by an action network 31, the action value u(t) at time t with the wind speeds v(t) and v(t−1) collected by the wind speed collecting system 1 and the rotor angular speed to ω(t) as inputs;

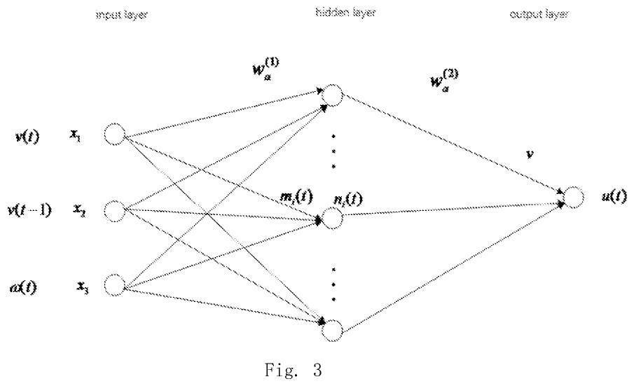

As shown in FIG. 3, in the embodiments of the present disclosure, the action network 31 is a three-layer BP neural network, including: input layer, output layer, and a hidden layer. u(t) is calculated using the equations belows:

$${m}_{i} ( t ) = {\sum }_{j = 1}^{n} {w}_{{a}_{ij}}^{( 1 )} ( t ) {x}_{j} ( t ) , \\ {n}_{i} ( t ) = \frac{1 - {exp}^{- {m}_{i} ( t )}}{1 + {exp}^{- {m}_{i} ( t )}} , \\ v ( t ) = {\sum }_{i = 1}^{{N}_{h}} {w}_{{a}_{i}}^{( 2 )} ( t ) {n}_{i} ( t ) , \\ u ( t ) = \frac{1 - {exp}^{- v ( t )}}{1 + {exp}^{- v ( t )}} ,$$

where wₐ_{ᵢⱼ}⁽¹⁾(t) denotes the weight of the action network 31 from the j^{th} node of the input layer to the i^{th} node of the hidden layer at sampling time t, wₐ_{ᵢ}⁽²⁾(t) denotes the weight of the action network 31 from the i^{th} node of the hidden layer to the output node at sampling time t; xⱼ denotes the input to the i^{th} node of the input layer, mᵢ denotes the input to the i^{th} node of the hidden layer of the action network 31; nᵢ denotes the output of the i^{th} node of the hidden layer of the action network 31; v denotes the input to the output layer of the action network 31; and u denotes the output of the output layer of the action network 31, wherein the pitch angle of the wind power generator is controlled based on u.

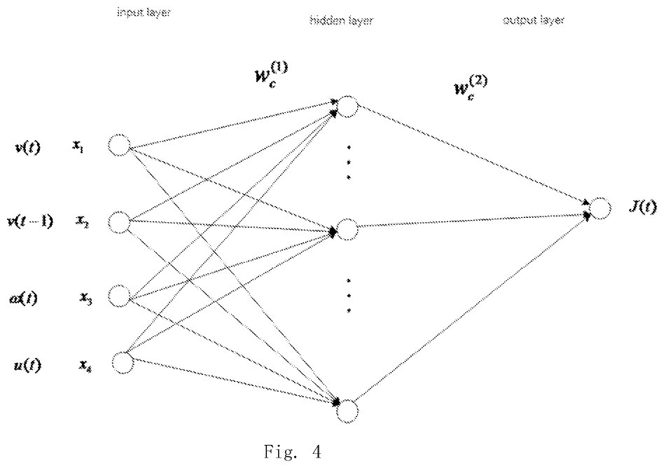

S4: calculating, by a critic network 32, a cumulative return value J(t) with the wind speed values v(t), v(t−1), the rotor angular speed ω(t), and the action value u(t) as inputs into the critic network 32; as shown in FIG. 4, in the embodiments of the present disclosure, the critic network 32 is a three-layer BP neural network, including an input layer, an output layer, and a hidden layer. J(t) is derived through the following equation:

$$J ( t ) = {\sum }_{i = 1}^{{N}_{h}} {w}_{{c}_{i}}^{( 2 )} ( t ) {p}_{i} ( t ) , where$$

$${p}_{i} ( t ) = \frac{1 - {exp}^{- {q}_{i} ( t )}}{1 + {exp}^{- {q}_{i} ( t )}} , \\ {q}_{i} ( t ) = {\sum }_{j = 1}^{n + 1} {w}_{{c}_{ij}}^{( 1 )} ( t ) {x}_{j} ( t ) , and$$

$${w}_{{c}_{ij}}^{( 1 )} ( t )$$

denote the weights of the critic network from the i^{th} node of the input layer to the j^{th} node of the hidden layer at sampling time t, w_{c}_{ᵢ}⁽²⁾ denotes the weight of the critic network from the i^{th} node of the hidden layer to the node of output layer at sampling time t; qᵢ(t) denotes the input to the i-th node of the hidden layer of the critic network; pᵢ(t) denotes the output of the i-th node of the hidden layer of the critic network; Nₕ denotes the total number of nodes of the hidden layer of the critic network; n+1 denotes the total number of inputs to the critic network plus the output u(t) of the action network 31; in the embodiments of the present disclosure, n is 3.

S5: performing, by the critic network 32, learning training based on the reinforcement signal r(t), and iteratively updating a network weight of the critic network 32 and the cumulative return value J(t);

Step S5 specifically comprises:

S51: setting a predicted error e_{c}(k) of the critic network 32 to e_{c}(k)=aJ(k)−[J(k−1)−r(k)], where α denotes a discount factor; setting the to-be-minimized target function E _{c}(k) of the critic network to E_{c}(k)=½e_{c}²(k), where k denotes the number of iterations; J(k) denotes a result outputted by the critic network 32 after the k-th iteration with the wind speed value v(t), the rotor angular speed ω(t), and the action value u(t) in step S4 as inputs to the critic network, where r(k) is equal to r(t) in step S2, which does not vary with the number of iteration;;

S52: setting the critic network weight updating rule to w_{c}(k+1)=w_{c}(k)+w_{c}(k), and iteratively updating the network weight of the critic network based on the critic network weight updating rule;

where w_{c}(k) denotes the network weight of the critic network after the k-th iteration, Δw_{c}(k) denotes the difference value of the network weight of the critic network at k -th iteration,

$$Δ {w}_{c} ( k ) = {l}_{c} ( k ) \cdot [ - \frac{\partial {E}_{c} ( k )}{\partial J ( k )} \cdot \frac{\partial J ( k )}{\partial {w}_{c} ( k )} ] ;$$

and l_{c}(k) denotes learning rate of the critic network, wherein the initial weight value of the critic network 32 is stochastic.

As shown in FIG. 4, Δw_{c}⁽²⁾ denotes the weight of the critic network from the hidden layer to the output layer, wherein the update equation is

$${w}_{{c}_{i}}^{( 2 )} ( k ) = {l}_{c} ( k ) [ - \frac{\partial {E}_{c} ( k )}{\partial {w}_{{c}_{i}}^{( 2 )} ( k )} ] = {l}_{c} ( k ) [ - α {e}_{c} ( k ) {p}_{i} ( k ) ] ;$$

for the same reasoning, Δw_{c}⁽¹⁾ denotes the weight of the critic network from the input layer to the hidden layer, wherein the update equation is

$$Δ {w}_{{c}_{ij}}^{( 1 )} ( k ) = {l}_{c} ( k ) [ - \frac{\partial {E}_{c} ( k )}{\partial {w}_{{c}_{ij}}^{( 1 )} ( k )} ] = - α {l}_{c} ( k ) {e}_{c} ( k ) {w}_{{c}_{i}}^{( 2 )} ( k ) \cdot [ \frac{1}{2} ( 1 - {p}_{i}^{2} ( k ) ) ] {x}_{j} ( k ) .$$

The critic network weight updating rule is obtained based on the chain rule and the backpropagation algorithm. The chain rule is a rule for finding derivative in calculus, the theorem of which is described as follows: if functions u=ϕ(x) and v=ψ(x) are both derivatives at point x, and the function z=f (u, v) has a continuous partial derivative at the corresponding point (u, v), it is satisfied that the function z=f[φ(x), ψ(x)] is derivative at the corresponding x, and the derivative of which may be calculated using:

$$\frac{dz}{dx} = \frac{\partial z}{\partial u} \frac{du}{dx} + \frac{\partial z}{\partial v} \frac{dv}{dx} .$$

The backpropagation algorithm is a learning algorithm applicable to a multi-layer neural network, which mainly leverages repetitive and cyclic iteration of two procedures (excitation propagation and weight update) so as to find the partial derivatives of the target function with respect to the weight values of respective neurons layer by layer, where the gradient of the target function with respect to the weight vector is used as the basis for modifying the weight value, till the network response to the input reaches the predetermined target scope.

S53: when the number of iterations k reaches the set upper limit of critic network updates, or the predicted error e_{c}(k) of the critic network 32 is less than a first error threshold as set, stopping iteration, and outputting J(k) to the action network 31 by the critic network 32.

S6: performing, by the action network 31, learning training with the updated cumulative return value J(t) obtained in step S5, and iteratively updating the network weight of the action network 31 and the action value u(t);

Step S6 specifically comprises:

S61: setting the predicted error of the action network 31 to eₐ(k)=J(k)−U_{c}(k), where U_{c}(k) denotes the final expected value of the action network 31, which is 0; setting the target function of the action network 31 to Eₐ(k)=½eₐ²(k), where k denotes the number of iteration; J(k) is equal to the output value of the critic network 32 in step S53, which does not vary with the number of iterations.

S62: setting the critic network weight updating rule to wₐ(k+1)=wₐ(k)+Δwₐ(k), and iteratively updating the network weight of the action network based on the action network weight updating rule;

where wₐ(k) denotes network weight of the action network at the k-th iteration, wₐ(k+1) denotes the network weight of the action network at the k+1-th iteration, and Δwₐ(k) denotes the difference value of the network weight of the action network at the k-th iteration

$$Δ {w}_{a} ( k ) = {l}_{a} ( k ) \cdot [ - \frac{\partial {E}_{a} ( k )}{\partial J ( k )} \cdot \frac{\partial J ( k )}{\partial u ( k )} \cdot \frac{\partial u ( k )}{\partial {w}_{a} ( k )} ] ,$$

where the initial weight of the action network is stochastic;

lₐ(k) denotes learning rate of the action network; u(k) denotes the action value outputted at the k-th iteration;

S63: stopping iteration when the number of iterations k reaches the set upper limit of action network updates or the predicted error eₐ(k) of the action network is less than a second error threshold as set; and outputting, via the action network, the updated action value u(t) at time t with the wind speeds v(t), v(t−1), and the rotor angular speed ω(t) in step S3 as inputs to the action network 31.

S7: outputting u(t) by the action network when the action network determines, based on the reinforcement signal r(t), that the difference between the rotor angular speed ω(t) and the rated rotor angular speed lies in a preset error range, in which case the method proceeds to step S8; otherwise, not outputting u(t), in which case the method returns to step S1.

In the present disclosure, irrespective of whether the preceding control succeeds or not, the learning trainings of the action network and critic network at the current time are still performed, such that the action network and the critic network form a memory of the input data. It is determined whether to output the results of the learning at the current time after the critic network and the action network complete their own learning trainings.

S8: generating, by a control signal generating module 4 based on a preset mapping function rule, a pitch angle value β corresponding to the action value u(t) obtained in step S6, and generating a control signal corresponding to the pitch angle value β; if u(t) is greater than or equal to 0, taking the pitch angle value β as a preset positive number; if u(t) is less than 0, taking the pitch angle value β as a preset negative number. It is seen from the wind turbine system transmission model that when β has a positive value, the rotor angular speed decreases; when β has a negative value, the rotor angular speed increases. The wind power generator varies the pitch angle of the wind power generator based on the control signal to thereby adjust the rotor angular speed ω(t) ; and updating t to t+1, then repeating steps S1-S8.

In the method for reinforcement learning-based real time robust variable pitch control of a wind turbine system, after the action network 31 generates an action value, the critic network 32 evaluates the action value, and updates the weight of the critic network 32 based on the reinforcement signal, thereby obtaining a cumulative return value. The obtained cumulative return value is returned to affect the weight update of the action network 31 so as to obtain a currently optimal output value of the action network, i.e., the updated action value. The updated action value is leveraged to control the wind turbine pitch angle.

Compared with the prior art, the present disclosure offers the following advantages:

1) the present disclosure provides a system and a method for reinforcement learning-based real time robust variable pitch control of a wind turbine system, which leverage a reinforcement learning module. The reinforcement learning module includes an action network 31 and a critic network 32. With the action network 31 and the critic network 32 and based on the real-time collected wind speed and rotor angle speed, a control signal is generated in real time through learning trainings to adjust the wind turbine pitch angle. By feeding back a reinforcement signal to the reinforcement learning module, the present disclosure further enables the reinforcement learning module to know whether to continue or avoid, in the next step, the same control measure as the current step. In this way, the present disclosure enables real-time control of the stability of the rotor angular speed under a rated angular speed and enables the pitch angle to vary smoothly and stably. Compared with conventional variable pitch control methods, the present disclosure has less damages to the wind turbine system equipment and facilitates extending of the service life of such equipment.

2) The conventional optimal control generally requires offline design by solving an HJB equation so as to enable a given system performance index to reach the maximum value (or minimum value), which requires leveraging a complete set of system dynamics knowledge. Further, it is always difficult or even impossible to determine the optimal control policy of a nonlinear system using the offline solution of the HJB equation. However, the present disclosure can guarantee a stable power output of the wind turbine only through autonomous learning training of the reinforcement learning module using the real-time detected rotor angular speed and wind speed. The present disclosure has advantages such as quick calculation, precise control, and sensitive response, which is less demanding on dynamics. Besides, the present disclosure has a wide array of applications and a stable and reliable effect.

What have been described above are only preferred embodiments for implementing the present disclosure. However, the scope of the present disclosure is not limited thereto. Any person of normal skill in the art may easily contemplate other variations or substitutions within the technical scope of the present disclosure, all of which should be included within the protection scope present disclosure. Therefore, the protection scope of the present disclosure should be limited by the appended claims.

1. A system for reinforcement learning-based real time robust variable pitch control of a wind turbine system, comprising:
a wind speed collecting system configured to collect wind speed data of a wind farm to generate a real-time wind speed value;
a wind turbine information collecting module connected to a wind power generator, configured to collect a rotor angular speed of the wind power generator;
a reinforcement signal generating module in signal connection with the wind turbine information collecting module, configured to generate in real time a reinforcement signal based on the collected rotor angular speed and a rated rotor angular speed;
a variable pitch robust control module, which is also referred to as a reinforcement learning module, comprising an action network and a critic network, wherein the action network is in signal connection with the wind speed collecting system and the wind turbine information collecting module and configured to generate an action value based on the real-time wind speed value and the rotor angular speed received and output the action value to the critic network; the critic network is in connection with the wind speed collecting system, the wind turbine information collecting module, and the reinforcement signal generating module and configured to generate a cumulative return value based on the real-time wind speed value, the rotor angular speed, and the action value received, perform learning training based on the reinforcement signal received, and iteratively update the cumulative return value and the critic network; and the action network performs learning training based on the updated cumulative return value to iteratively update the action network and the action value; and
a control signal generating module disposed between and in signal connection with the reinforcement learning module and the wind power generator, configured to generate, based on the set mapping function, a control signal corresponding to the action value iteratively updated by the action network, wherein the wind power generator adjusts the pitch angle based on the control signal to thereby adjust the rotor angular speed.

2. The system for reinforcement learning-based real time robust variable pitch control of a wind turbine system according to claim 1, wherein the action network and the critic network are both of a BP neural network, which perform learning training with a backpropagation algorithm.

3. A method for reinforcement learning-based real time robust variable pitch control of a wind turbine system, which is implemented by the system for reinforcement learning-based real time robust variable pitch control of a wind turbine system according to claim 1, comprising steps of:
S1: collecting, by a wind speed collecting system, wind speed data of a wind farm, and generating a real-time wind speed value v(t) of the wind farm based on the wind speed data; and
collecting, by a wind turbine information collecting module, a rotor angular speed ω(t) of the wind power generator; where t denotes sampling time;
S2: comparing, by a reinforcement signal generating module, the rotor angular speed ω(t) with a rated rotor angular speed to generate a reinforcement signal r(t), wherein the reinforcement signal r(t) indicates whether the difference between the rotor angular speed ω(t) and the rated rotor angular speed lies in a preset error range;
S3: calculating, by an action network, the action value u(t) at time t with the wind speed values v(t) and v(t−1) collected by the wind speed collecting system and the rotor angular speed ω(t) as inputs;
S4: calculating, by a critic network, a cumulative return value with the wind speed values v(t) and v(t−1), the rotor angular speed ω(t), and the action value u(t) as inputs to the critic network;
S5: performing, by the critic network, learning training based on the reinforcement signal r(t), and iteratively updating a network weight of the critic network and the cumulative return value J(t);
S6: performing, by the action network, learning training with the updated cumulative return value J(t) obtained in step S5, and iteratively updating the network weight of the action network and the action value u(t);
S7: outputting u(t) by the action network when the action network determines, based on the reinforcement signal r(t) , that the difference between the rotor angular speed ω(t) and the rated rotor angular speed lies in a preset error range, in which case the method proceeds to step S8; otherwise, not outputting u(t), in which case the method returns to step S1;
S8: generating, by a control signal generating module based on a preset mapping function rule, a pitch angle value β corresponding to the action value u(t) obtained in step S6, and generating a control signal corresponding to the pitch angle value β; varying, by the wind power generator based on the control signal, a pitch angle of the wind power generator to thereby adjust the rotor angular speed ω(t); and updating t to t+1, then repeating steps S1-S8.

4. The method for reinforcement learning-based real time robust variable pitch control of a wind turbine system according to claim 3, wherein Step S1 of collecting, by a wind speed collecting system, wind speed data of a wind farm, and generating a real-time wind speed value v(t) of the wind farm based on the wind speed data specifically comprises:
S11: generating, by the wind speed collecting system, an average wind speed value v̅=Σᵢ₌₁^{t-1}v(i)/(t−1) based on the collected wind speed values v(1)˜v(t−1), where t denotes sampling time;
S12: calculating a turbulent speed v′(t) of sampling time t according to an auto-regressive moving average method, v′(t)=Σᵢ₌₁ⁿαᵢv′(t−i)+a(t)+Σⱼ₌₁^{m}βⱼa(t−j), where a(·) denotes a white noise sequence of Gaussian distribution, n denotes an autoregressive order; m denotes a moving average order; αᵢ denotes an autoregressive coefficient, βⱼ denotes a moving average coefficient, and σₐ² denotes a variance of the white noise a(t);
S13: generating the wind speed value v(t)=1.7 +1.:5′(_{.}0 of the sampling time t.

5. The method for reinforcement learning-based real time robust variable pitch control of a wind turbine system according to claim 3, wherein Step S2 of generating the reinforcement signal r(t) specifically comprises: if the difference between the rotor angular speed ω(t) and the rated rotor angular speed lies within a preset error range, r(t)=0; otherwise, r(t)=−1.

6. The method for reinforcement learning-based real time robust variable pitch control of a wind turbine system according to claim 3, wherein Step S5 specifically comprises:
S51: setting a predicted error e_{c}(k) of the critic network to e_{c}(k)=αJ(k)−[J(k−1)−r(k)], where α denotes a discount factor; setting the to-be-minimized target function E_{c}(k) of the critic network to E_{c}(k)=½e_{c}²(k), where denotes the number of iterations; J(k) denotes a result outputted by the critic network after the k-th iteration with the wind speed value v(t), the rotor angular speed ω(t), and the action value u(t) in step S4 as inputs to the critic network, where r(k) is equal to r(t) in step S2, which does not vary with the number of iteration;
S52: setting the critic network weight updating rule to w_{c}(k−1)=w_{c}(k)+Δw_{c}(k), and iteratively updating the network weight of the critic network based on the critic network weight updating rule;
where w_{c}(k) denotes the network weight of the critic network after the k-th iteration, Δw_{c}(k) denotes the difference value of the network weight of the critic network at k-th iteration,
$$Δ {w}_{c} ( k ) = {l}_{c} ( k ) \cdot [ - \frac{\partial {E}_{c} ( k )}{\partial J ( k )} \cdot \frac{\partial J ( k )}{\partial {w}_{c} ( k )} ] ;$$
and l_{c}(k) denotes learning rate of the critic network;
S53: when the number of iterations k reaches the set upper limit of critic network updates, or the predicted error e_{c}(k) of the critic network is less than a first error threshold as set, stopping iteration, and outputting 1(k) to the action network by the critic network.

7. The method for reinforcement learning-based real time robust variable pitch control of a wind turbine system according to claim 3, wherein Step S6 specifically comprises:
S61: setting the predicted error of the action network to eₐ(k)=J(k)=J(k)−U_{c}(k), where U_{c}(k) denotes the final expected value of the action network, which is 0; setting the target function of the action network to Eₐ(k)=½eₐ²(k), where k denotes the number of iterations; J(k) is equal to the output value of the critic network in step S53, which does not vary with the number of iterations.
S62: setting the action network weight updating rule to wₐ(k+1)=wₐ(k)+Δwₐ(k), and iteratively updating the network weight of the action network based on the action network weight updating rule;
where wₐ(k) denotes network weight of the action network at the k-th iteration, wₐ(K+1) denotes the network weight of the action network at the k+1-th iteration, and Δwₐ(k) denotes the difference value of the network weight of the action network at the k-th iteration,
$$Δ {w}_{a} ( k ) = {l}_{a} ( k ) \cdot [ - \frac{\partial {E}_{a} ( k )}{\partial J ( k )} \cdot \frac{\partial J ( k )}{\partial u ( k )} \cdot \frac{\partial u ( k )}{\partial {w}_{a} ( k )} ] ,$$
where lₐ(k) denotes learning rate of the action network; u(k) denotes the action value outputted at the k-th iteration;
S63: stopping iteration when the number of iterations k reaches the set upper limit of action network updates or the predicted error eₐ(k) of the action network is less than a second error threshold as set; and outputting, via the action network, the updated action value u(t) at time t with the wind speeds v(t), v(t−1), and the rotor angular speed ω(t) in step S3 as inputs to the action network.

8. The method for reinforcement learning-based real time robust variable pitch control of a wind turbine system according to claim 3, wherein the mapping function rule in step S8 specifically refers to:
if u(t) is greater than or equal to 0, taking the pitch angle value β as a preset positive number; if u(t) is less than 0, taking the pitch angle value β as a preset negative number.

9. A method for reinforcement learning-based real time robust variable pitch control of a wind turbine system, which is implemented by the system for reinforcement learning-based real time robust variable pitch control of a wind turbine system according to claim 2, comprising steps of:
S1: collecting, by a wind speed collecting system, wind speed data of a wind farm, and generating a real-time wind speed value v(t) of the wind farm based on the wind speed data; and
collecting, by a wind turbine information collecting module, a rotor angular speed ω(t) of the wind power generator; where t denotes sampling time;
S2: comparing, by a reinforcement signal generating module, the rotor angular speed ω(t) with a rated rotor angular speed to generate a reinforcement signal r(t) wherein the reinforcement signal r(t) indicates whether the difference between the rotor angular speed ω(t) and the rated rotor angular speed lies in a preset error range;
S3: calculating, by an action network, the action value u(t) at time t with the wind speed values v(t) and v(t−1) collected by the wind speed collecting system and the rotor angular speed ω(t) as inputs;
S4: calculating, by a critic network, a cumulative return value J(t) with the wind speed values v(t) and v(t−1), the rotor angular speed ω(t), and the action value u(t) as inputs to the critic network;
S5: performing, by the critic network, learning training based on the reinforcement signal r(t), and iteratively updating a network weight of the critic network and the cumulative return value J(t);
S6: performing, by the action network, learning training with the updated cumulative return value J(t) obtained in step S5, and iteratively updating the network weight of the action network and the action value u(t);
S7: outputting u(t) by the action network when the action network determines, based on the reinforcement signal r(t), that the difference between the rotor angular speed ω(t) and the rated rotor angular speed lies in a preset error range, in which case the method proceeds to step S8; otherwise, not outputting u(t), in which case the method returns to step S1;
S8: generating, by a control signal generating module based on a preset mapping function rule, a pitch angle value β corresponding to the action value u(t) obtained in step S6, and generating a control signal corresponding to the pitch angle value β; varying, by the wind power generator based on the control signal, a pitch angle of the wind power generator to thereby adjust the rotor angular speed ω(t); and updating t to t+1, then repeating steps S1-S8.

10. The method for reinforcement learning-based real time robust variable pitch control of a wind turbine system according to claim 9, wherein Step S1 of collecting, by a wind speed collecting system, wind speed data of a wind farm, and generating a real-time wind speed value v(t) of the wind farm based on the wind speed data specifically comprises:
S11: generating, by the wind speed collecting system, an average wind speed value v̅=Σᵢ₌₁^{t-1}v(i)/(t−1) based on the collected wind speed values v(1)˜v(t−1), where t denotes sampling time;
S12: calculating a turbulent speed v′(t) of sampling time t according to an auto-regressive moving average method, v′(t)=Σᵢ₌₁ⁿαᵢv′(t−i)+a(t)+Σⱼ₌₁^{m}βⱼa(t−j), where a(·) denotes a white noise sequence of Gaussian distribution, n denotes an autoregressive order; m denotes a moving average order; αᵢ denotes an autoregressive coefficient, βⱼ denotes a moving average coefficient, and σₐ² denotes a variance of the white noise a(t);
S13: generating the wind speed value v(t)=v̅+v′(t) of the sampling time t.

11. The method for reinforcement learning-based real time robust variable pitch control of a wind turbine system according to claim 9, wherein Step S2 of generating the reinforcement signal r(t) specifically comprises: if the difference between the rotor angular speed ω(t) and the rated rotor angular speed lies within a preset error range, r(t)=0; otherwise, r(t)=−1.

12. The method for reinforcement learning-based real time robust variable pitch control of a wind turbine system according to claim 9, wherein Step S5 specifically comprises:
S51: setting a predicted error e_{c}(k) of the critic network to e_{c}(k)=αJ(k)−[J(k−1)−r(k)], where α denotes a discount factor; setting the to-be-minimized target function E_{c}(k) of the critic network to E_{c}(k)=½e_{c}²(k), where k denotes the number of iterations; J(k) denotes a result outputted by the critic network after the k-th iteration with the wind speed value v(t), the rotor angular speed ω(t), and the action value u(t) in step S4 as inputs to the critic network, where r(k) is equal to r(t) in step S2, which does not vary with the number of iteration;
S52: setting the critic network weight updating rule to w_{c}(k+1)=w_{c}(k)+Δw_{c}(k), and iteratively updating the network weight of the critic network based on the critic network weight updating rule;
where w_{c}(k) denotes the network weight of the critic network after the k-th iteration, Δw_{c}(k) denotes the difference value of the network weight of the critic network at k-th iteration,
$$Δ {w}_{c} ( k ) = {l}_{c} ( k ) \cdot [ - \frac{\partial {E}_{c} ( k )}{\partial J ( k )} \cdot \frac{\partial J ( k )}{\partial {w}_{c} ( k )} ] ;$$
and) denotes learning rate of the critic network;
S53: when the number of iterations k reaches the set upper limit of critic network updates, or the predicted error e_{c}(k) of the critic network is less than a first error threshold as set, stopping iteration, and outputting J(k) to the action network by the critic network.

13. The method for reinforcement learning-based real time robust variable pitch control of a wind turbine system according to claim 9, wherein Step S6 specifically comprises:
S61: setting the predicted error of the action network to eₐ(k)=J(k)−U_{c}(k), where U_{c}(k) denotes the final expected value of the action network, which is 0; setting the target function of the action network to Eₐ(k)=½eₐ²(k), where k denotes the number of iterations; J(k) is equal to the output value of the critic network in step S53, which does not vary with the number of iterations.
S62: setting the action network weight updating rule to wₐ(k−1)=wₐ(k)+Δwₐ(k), and iteratively updating the network weight of the action network based on the action network weight updating rule;
where wₐ(k) denotes network weight of the action network at the k-th iteration, wₐ(k+1) denotes the network weight of the action network at the k+1-th iteration, and Δwₐ(k) denotes the difference value of the network weight of the action network at the k-th iteration,
$$Δ {w}_{a} ( k ) = {l}_{a} ( k ) \cdot [ - \frac{\partial {E}_{a} ( k )}{\partial J ( k )} \cdot \frac{\partial J ( k )}{\partial u ( k )} \cdot \frac{\partial u ( k )}{\partial {w}_{a} ( k )} ] ;$$
where lₐ(k) denotes learning rate of the action network; u(k) denotes the action value outputted at the k-th iteration;
S63: stopping iteration when the number of iterations k reaches the set upper limit of action network updates or the predicted error eₐ(k) of the action network is less than a second error threshold as set; and outputting, via the action network, the updated action value u(t) at time t with the wind speeds v(t), v(t−1), and the rotor angular speed ω(t) in step S3 as inputs to the action network.

14. The method for reinforcement learning-based real time robust variable pitch control of a wind turbine system according to claim 9, wherein the mapping function rule in step S8 specifically refers to:
if u(t) is greater than or equal to 0, taking the pitch angle value β as a preset positive number; if u(t) is less than 0, taking the pitch angle value β as a preset negative number.
